(19) United States
(12) Patent Application Publication
(10) Pub. No.: US 2001/0016935 A1
(43) Pub. Date: Aug. 23, 2001

(54) System and method for verifying hardware description

(76) Inventor: Shinya Furusawa, Tokyo (JP)

Correspondence Address: Paul J. Esatto, Jr., Scully, Scott, Murphy & Presser, 400 Garden City Plaza, Garden City, NY, 11530, US

(21) Appl. No.: 09/777,543

(22) Filed: Feb. 6, 2001

(30) Foreign Application Priority Data
Feb. 9, 2000 (JP) 032355/2000

(51) Int. Cl. G06F 17/50

(52) U.S. Cl. 716/4; 716/5; 716/6

(57) ABSTRACT

A hardware description verifying system includes a storage unit, an output unit and a processor. The storage unit stores a source program for hardware description in a program language. The processor detect a portion of the source program different in logic interpretation between a case of compiling the source program using a compiler and a case of behavioral synthesis, and outputs existence of the source program portion to the output unit.

### BACKGROUND OF THE INVENTION

1. Field of the Invention

The present invention relates to a system and a method for verifying hardware description. More particularly, the present invention relates to a system and a method for verifying a hardware description, for verifying discrepancies between a program obtained by compiling hardware description in a programming language and behavioral synthesis of the hardware description.

2. Description of the Related Art

Conventionally, a hardware description language (HDL) is used for the design of hardware, and a software program for controlling the hardware is written in a programming language. The total verification of the hardware and the software program is generally carried out using a simulator called a co-simulator, which is operable with both of a hardware description language and a programming language. At this time, a software model is simulated on a hardware model to be verified. Thus, the hardware model is verified. However, when the hardware description language for the hardware model and the programming language for the software model are cooperated with each other for verifying the hardware model, the verification time is significantly dependent on the speed of the hardware simulation. For this reason, both of the hardware model and the software model are described in programming languages without using the hardware description language for high-speed verification. For example, the hardware model is described in an advanced programming language, such as C, C++, or Java, which is commonly used for developing types of software.

Generally, two major steps shown in FIG. 1 are necessary for the design of a new circuit. Such steps are a function verifying step S101 and a behavioral synthesizing step S102. At the function verifying step S101, a source program in a programming language for the hardware descriptions is compiled into an executable program, and functions are verified using the executable program. At the step S102, the hardware descriptions in the hardware language are synthesized in operation into a register transfer level (RTL) description.

However, in this case, another problem has arisen. The programming language for software development is not always applicable to the hardware design. For example, the simultaneous parallel operations of circuits cannot be described in a general programming language. For the purpose that the programming language for software development meets the requirements for the hardware design, the programming language is modified so as to extend operation specifications. However, there is a possibility that any discrepancy is in logic interpretation between the hardware descriptions in the program language with an extended function and the hardware descriptions in the hardware language. Accordingly, it is necessary to verify the equality between the hardware descriptions in the extended program language and the hardware descriptions in the hardware description language. In this case, even if the discrepancy is founded, the reason why the discrepancy is caused and the sentence from which the discrepancy is caused are not manifest. More time is required to make the reason and the description manifest.

In conjunction with the above description, an apparatus for designing an electronic circuit using a program language is disclosed in Japanese Laid Open Patent Application (JP-A-Heisei 10-149382). In this reference, a specific process section (2) sequentially specifies first portions to be controlled, of a program describing a circuit behavior in a general program language. A converting process section (3) converts the first portions into a program (4) using a general program language so as to operate as a state machine. Subsequently, a program producing process section (5) extracts second portions which circuits in the general program language are operated in parallel and produces a program (6) to access all the second portions. Further, an extracting process section extracts a first accessing portion to hardware from a control program for controlling circuits described in a conversion and production program which is composed of the converted program (4) and the produced program (6). A first adding process section inserts immediately before the first accessing portion, a program for detecting an executing time of the first accessing portion and a program for measuring an execution time period between the first accessing portion and a second accessing portion immediately before the first accessing portion. A second adding process section inserts immediately before the first accessing portion, a program operating the conversion and production program for clocks corresponding to the execution time period obtained by the program inserted by the first adding process section.

### SUMMARY OF THE INVENTION

Therefore, an object of the present invention is to provide a system and a method for verifying hardware description while a portion of a source program for hardware description where its interpretation is different between the programming language and a hardware description language is detected.

Another object of the present invention is to provide a system and a method for verifying the hardware description, where the verification of equality can be omitted which is necessary when logic interpretation is not equal between the programming language and the hardware description language.

In an aspect of the present invention, a hardware description verifying system includes a storage unit, an output unit and a processor. The storage unit stores a source program for hardware description in a program language. The processor detect a portion of the source program different in logic interpretation between a case of compiling the source program using a compiler and a case of behavioral synthesis, and outputs existence of the source program portion to the output unit.

The processor may detect the source program portion in which a variable of a register type is referred to at a clock timing after substitution to the variable at the clock timing. In this case, the processor may include a signal list storage section and a processing section. The processing section sequentially reads out sentences of the source program, and deletes a storage content in the signal list storage section when the read out sentence indicates a clock boundary. Also, the processing unit stores the variable in the signal list storage section when the read out sentence indicates the substitution to the variable at the clock timing, and outputs the existence of the read out sentence to the output unit when the read out sentence refers to the variable which is stored in the signal list storage section.

Also, the processor may detect the source program portion in which substitution to a variable of a non-overwrite type is carried out twice or more at a clock timing. In this case, the processor may include a signal list storage section and a processing section. The processing section sequentially reads out sentences of the source program, and deletes a storage content in the signal list storage section when the read out sentence indicates a clock boundary. Also, the processing unit stores the variable in the signal list storage section when the read out sentence indicates the substitution to the variable at the clock timing and the variable is not stored in the signal list storage section, and outputs the existence of the read out sentence to the output unit when the read out sentence indicates the substitution to the variable at the clock timing and the variable is stored in the signal list storage section.

Also, the processor may detect the source program portion in which a variable for a non-register type is referred to at a clock timing without substitution of the value to the variable at the clock timing. In this case, the processor may include a signal list storage section and a processing section. The processing unit sequentially reads out sentences of the source program, and deletes a storage content in the signal list storage section when the read out sentence indicates a clock boundary. Also, the processing unit stores the variable in the signal list storage section when the read out sentence indicates the substitution to the variable at the clock timing, and outputs the existence of the read out sentence to the output unit when the read out sentence refers to the variable which is not stored in the signal list storage section, at the clock timing.

Also, the processor may detect the source program portion in which a variable of a wiring line is referred to at a clock timing and then a value is substituted to the variable at the clock timing. In this case, the processor may include a signal list storage section and a processing section. The processing unit sequentially reads out sentences of the source program, and deletes a storage content in the signal list storage section when the read out sentence indicates a clock boundary. Also, the processing unit stores the variable in the signal list storage section when the read out sentence indicates the substitution to the variable at the clock timing, and outputs the existence of the read out sentence to the output unit when the read out sentence refers to the variable which is not stored in the signal list storage section, at the clock timing.

Also, the processor detects the source program portion in which a logical operator is used and a right operand of the operator includes a variable with substitution.

In another aspect of the present invention, a hardware description verifying method is attained by (a) detecting a portion of a source program different in logic interpretation between a case of compiling the source program using a compiler and a case of behavioral synthesis, the source program for hardware description being described in a program language; and by (b) alarming existence of the source program portion.

The source program portion may be a portion in which a variable of a register type is referred to at a clock timing after substitution to the variable at the clock timing. In this case, the (a) detecting may be attained by sequentially reading out sentences of the source program; by deleting a storage content in a signal list storage section when the read out sentence indicates a clock boundary; by storing the variable in the signal list storage section when the read out sentence indicates the substitution to the variable at the clock timing; and by detecting the read out sentence as the source program portion when the read out sentence refers to the variable which is stored in the signal list storage section.

Also, the source program portion may be a portion in which substitution to a variable of a non-overwrite type is carried out twice or more at a clock timing. In this case, the (a) detecting may be attained by sequentially reading out sentences of the source program; by deleting a storage content in a signal list storage section when the read out sentence indicates a clock boundary; by storing the variable in the signal list storage section when the read out sentence indicates the substitution to the variable at the clock timing and the variable is not stored in the signal list storage section; and by detecting the source program portion when the read out sentence indicates the substitution to the variable at the clock timing and the variable is stored in the signal list storage section.

Also, the source program portion may be a portion in which a variable for a non-register type is referred to at a clock timing without substitution of the value to the variable at the clock timing. In this case, the (a) detecting may be attained by: sequentially reading out sentences of the source program; by deleting a storage content in a signal list storage section when the read out sentence indicates a clock boundary; by storing the variable in the signal list storage section when the read out sentence indicates the substitution to the variable at the clock timing; and by detecting the source program portion when the read out sentence refers to the variable which is not stored in the signal list storage section, at the clock timing.

Also, the source program portion may be a portion in which a variable of a wiring line is referred to at a clock timing and then a value is substituted to the variable at the clock timing. In this case, the (a) detecting may be attained by sequentially reading out sentences of the source program; by deleting a storage content in the signal list storage section when the read out sentence indicates a clock boundary; by storing the variable in the signal list storage section when the read out sentence indicates the substitution to the variable at the clock timing; and by detecting the source program portion when the read out sentence refers to the variable which is not stored in the signal list storage section, at the clock timing.

Also, the processor detects the source program portion in which a logical operator is used and a right operand of the operator includes a variable with substitution.

In still another aspect of the present invention, a program is provided for a hardware description verifying method which may be attained by (a) detecting a portion of a source program different in logic interpretation between a case of compiling the source program using a compiler and a case of behavioral synthesis, the source program for hardware description being described in a program language; and by (b) alarming existence of the source program portion.

### BRIEF DESCRIPTION OF THE DRAWINGS

FIG. 1 is a diagram showing a problem in a conventional technique;

FIG. 2 is a block diagram showing the structure of a hardware description verifying system according to an embodiment of the present invention;

FIGS. 3 and 4 are circuit diagrams showing an example of register type variables;

FIG. 5 is a circuit diagram showing an example of a non-overwrite type variable;

FIG. 6 shows a procedure of detecting the presence of the register type verification object;

FIG. 7 is a diagram showing a verifying result of a source program for the register type verification object;

FIG. 8 shows a circuit diagram showing an example of a register type verification object;

FIG. 9 shows a procedure of detecting the presence of the non-overwrite type verification object;

FIG. 10 is a diagram showing a verifying result of a source program for the non-overwrite type verification object;

FIG. 11 shows a circuit diagram showing an example of a non-overwrite type verification object;

FIG. 12 is a diagram showing a verifying result of a source program for the non-register type verification object;

FIG. 13 is a diagram showing a cause of the verifying result;

FIG. 14 shows a procedure of detecting the presence of the non-register type verification object;

FIG. 15 is a diagram showing a verifying result of a source program for the wiring line type verification object;

FIG. 16 shows a circuit diagram showing an example of a wiring line type verification object;

FIG. 17 shows a procedure of detecting the presence of the wiring line type verification object;

FIG. 18 is a diagram showing a verifying result of a source program for an operator type verification object; and

FIG. 19 shows a procedure of detecting the presence of the operator type verification object.

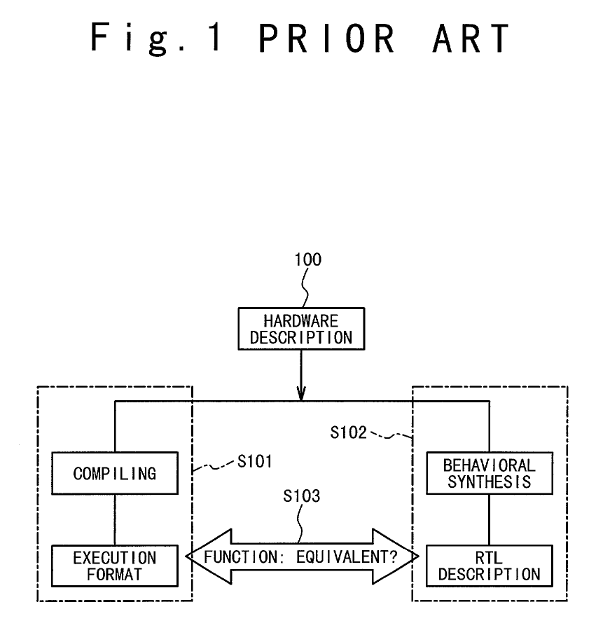

### DESCRIPTION OF THE PREFERRED EMBODIMENTS

Hereinafter, a hardware description verifying system of the present invention will be described below in detail with reference to the attached drawings.

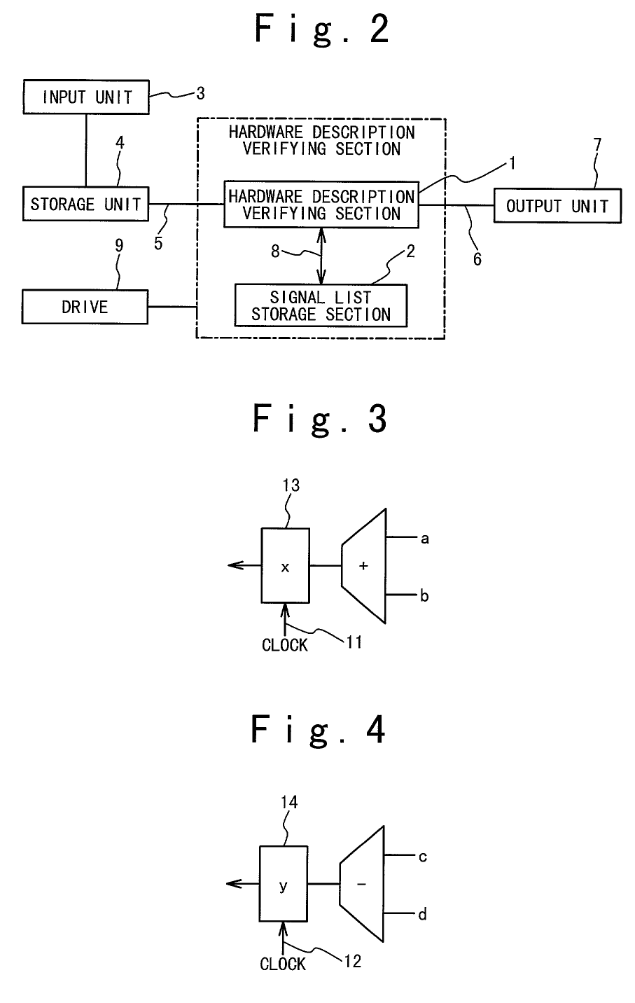

FIG. 2 is a block diagram showing the structure of the hardware description verifying system according to an embodiment of the present invention. Referring to FIG. 2, the hardware description verifying system in the embodiment is composed of an input unit 3, a storage unit 4, a hardware description verifying section 1, an output unit 7, and a drive unit 9. The hardware description verifying section 1 includes a signal list storage section 2.

A source program written in a program language for a circuit and compiled using a compiler is inputted from the input unit 3 to the storage unit 4. Also, a control program executed by the hardware description verifying section 1 is read out from a recording medium by the drive unit 9 and loaded on the verifying section 1.

The hardware description verifying section 1 executes the control program to receive a source program for the hardware description of the circuit from the storage unit 4 and to execute the verifying operation of the source program 5. When an error is found in a specific portion of the source program, the hardware description verifying section 1 outputs to the output unit 7 a warning signal 6 indicative of the presence of the specific portion together with the location of the specific portion and a corresponding portion of the hardware description model obtained by behavioral synthesis of the hardware descriptions, if the hardware description model is stored in the storage unit 4. The output unit 7 displays the alarm signal 6, the location of the specific portion and the corresponding portion of the hardware description model. The signal list storing section 2 stores and outputs a signal 8 indicative of a verification object variable.

The object to be verified is classified into five types in the present invention. The five types are referred to as a register type, a non-overwrite type, a non-register type, a wiring line type, and an operator depending type.

clock ( )

x=a+b

clock ( )

y=c−d

The above source program includes variables x and y. The variable x is described by referring to the values of a and b in a hardware description model. The variable y is also described by referring to the values of c and d in the hardware description model. In FIG. 3, the values of a and b are supplied to an adder and the addition result (a+b) of the adder is latched as the variable x by a register 13 in synchronous with a clock signal 11. Also, in FIG. 4, the values of c and d are supplied to a subtractor and the subtraction result (c−d) of the subtractor is latched as the variable y by a register 14 in synchronous with a clock signal 12. Thus, the variables x and y are updated in synchronous with clock signals 11 and 12. The two variables x and y are not updated at the timing when the values of a and b or c and d are supplied. The variable x and y are updated in synchronization with a clock description after the allocation of the data. The variable updated in synchronization with the clock description is referred to as a variable of the register type in the present invention. In this way, latches and registers in a circuit can be expressed with those variables.

1. Example of Register Type Verification Object

clock ( );

x=a+b;

y=x+t;

clock ( );

In the above program, the sentences x=a+b and y=x+t are provided between clock description sentences, clock ( ), corresponding to clock signals. The addition result of the values of a and b is substituted to the variable x in synchronization with the clock signal and then the variable x is substituted in the other variable y. When the variable is described or defined twice at the single clock signal, it is interpreted that the variable x does not have the same data in the behavioral synthesis of hardware descriptions in the hardware description language. However, a compiler interprets that the variable x has the same data. When the variable is updated in synchronization with the clock signal and then substituted to another variable in a sentence, the sentence is referred to as a register type verification object.

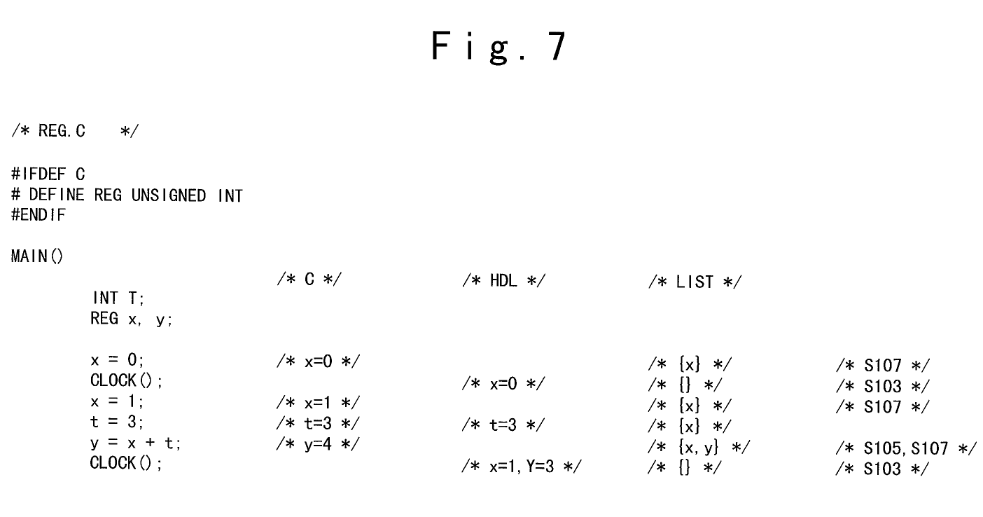

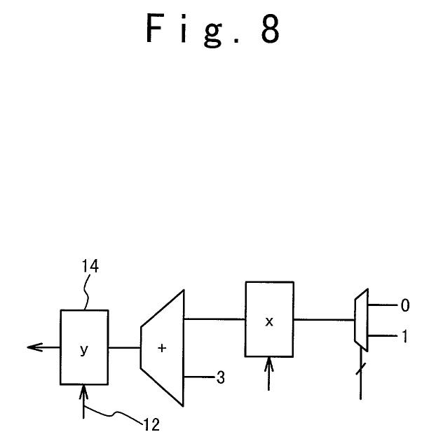

FIG. 7 shows another example of the register type verification object. The hardware description of the source program containing a sentence for the register type verification object is:

| | |
|---|---|
| int t; | |
| reg x, y; | |
| x = 0; | first text |
| clock(); | second text |
| x = 1; | third text |
| t = 3; | fourth text |
| y = x + t; | fifth text |
| clock(); | sixth text |

where the sentence “reg x, y” and the second and sixth sentences are written in the programming language with the extended function.

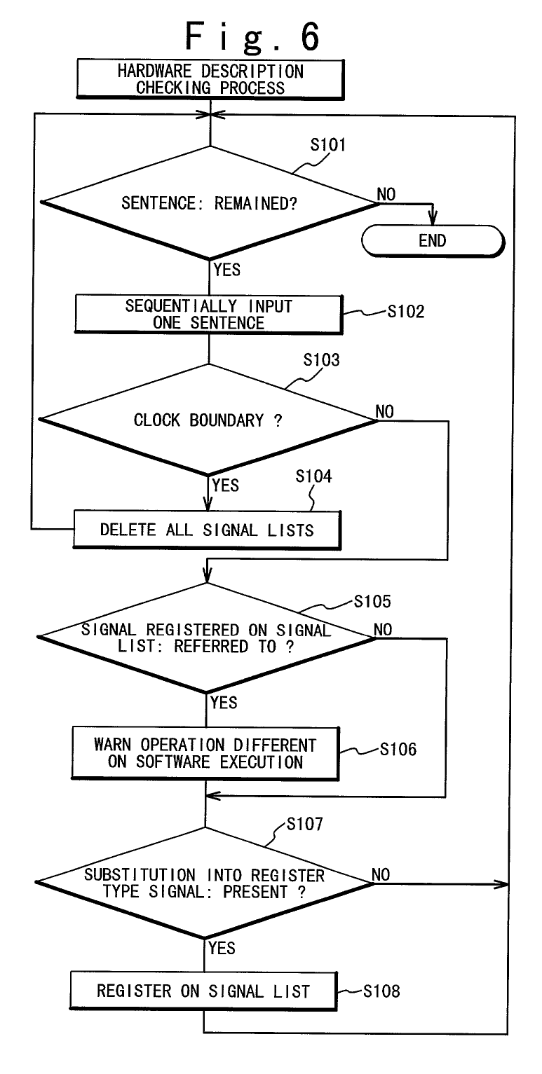

FIG. 6 shows a procedure of detecting the presence of the register type verification object. Referring to FIG. 6, the hardware description verifying section 1 sequentially reads out the sentences of the source program from the storage unit 4 one by one (step S102), when the sentences are remained (step S101). The first sentence is “x=0”. When the first sentence indicates a clock boundary, all the variables as data signals stored in the signal list storing section 2 are deleted. Since the first sentence is not the clock boundary, the procedure goes from the step S102 to a step S105. It is checked at the step S105 whether the read out sentence refers to any variable stored in the signal list storing section 2. When the read out sentence refers to the variable stored in the signal list storing section 2, there is a possibility that an unintentional behavior is carried out in the software execution. Therefore, the hardware description verifying section 1 outputs an alarm signal 6 to the output unit 7. Then the procedure advances to a step S107. No variable is now stored in the signal list storing section 2 and thus the procedure advances directly to the step S107. It is then checked at step S107 whether the substitution to the register type variable (x) is present. Since the first sentence includes the substitution to the register type variable, the procedure advances to a step S108.

At the step S108, when the substitution to the register type variable is present, the register type variable in the sentence is stored in the signal list storing section 2. When the register type variable x in the first sentence has been stored in the signal list storing section 2, the procedure returns back to the step S101.

Next, the second sentence “clock ( )” is inputted to the hardware description verifying section 1. Since the second sentence indicates a clock boundary, the variables stored in the signal list storing section 2 are deleted at the step S104. Then, the procedure then returns back to the step S101.

The third sentence “x=1” is inputted to the hardware description verifying section 1. Since the third sentence indicates no clock boundary, the procedure jumps to the step S105. Since no variable is registered in the signal list storage section 2, the procedure goes via the step S105 to the step S107 where it is determined that there is substitution to the register type variable x. Accordingly, the step S108 is executed to register the variable x in the signal list storage section 2.

Next, the fourth sentence “t=3” is inputted to the hardware description verifying section 1. Since the fourth sentence indicates no clock boundary, the procedure jumps to the step S105. Since the fourth sentence does not refer to the variable x, the procedure goes from the step S105 to step S107 where it is determined that the substitution to the register type variable is not present. Accordingly, the value of t is not registered in the signal list storage section 2 and the procedure returns back to the step S101.

The fifth sentence “y=x+t” is inputted to the hardware description verifying section 1. Since the fifth sentence indicates no clock boundary, the procedure jumps to the step S105. Since the variable y in the fifth sentence refers to the variable x registered in the signal list storing section 2, an alarm is outputted at the step S106. Then, it is determined at the step S107 that the substitution to the register type variable y is present so that the variable y in the fifth sentence is registered in the signal list storing section 2 as a signal y at the step S108. Next, the sixth sentence is inputted to the hardware description verifying section 1 and the two variables x and y are deleted from the signal list storing section 2.

In the third and fifth sentences between the clock boundary descriptions, the variable y in the fifth sentence refers to the third sentence which is another sentence. In this case, interpretation by the compiler for the C language is different from interpretation by the hardware description language (HDL), as shown in FIG. 7. Even when the source program is correctly written in a computer language, the interpretation may be different between the extended C language and the HDL language. As an example of such a case, there is a case that the variable substituted at a clock timing is referred to in another sentence at the same clock timing.

The value of 0 is substituted to the variable x in the HDL language at the clock timing of the second sentence. On the other hand, the value of 1 is substituted to the variable x in the C language. Therefore, y=3 in the HDL and y=4 in the C language. The sentences before and after the clock boundary of which a physical operation is executed by use of a register at the timing of a clock signal are interpreted and calculated differently between the C language and the HDL language. Since the interpretation is different, the fifth sentence produces different results by referring to the other sentence.

2. Non-Overwrite Type Verification Object

clock ( );

z=a+b;

z=c+d;

clock ( );

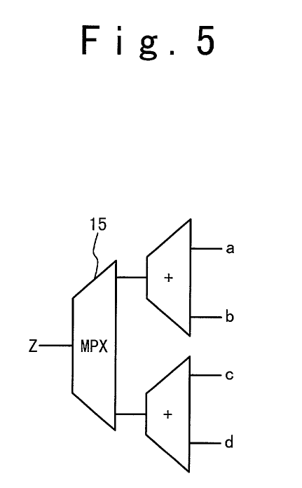

According to the above program, two sentences for the variable z are described by referring to the values of a and b and c and d in the hardware, respectively. It is defined that Z is a variable which is not overwritten at the same clock timing in the extended C language. Those variables are used for expressing a multiplexer in the actual circuit. One of the two variables z is described with the values of a and b while the other with the values of c and d. In the compiler, an upper one of the sentences for the two variables z is substituted in the lower equation. Hence, the variable z of the lower sentence is valid. As shown in FIG. 5, the HDL interprets in behavioral synthesis that one of (a+b) and (c+d) is selected by a multiplexer (MX) 15. With the non-overwrite type, the twice substitutions to the variable at the same clock timing are not permitted.

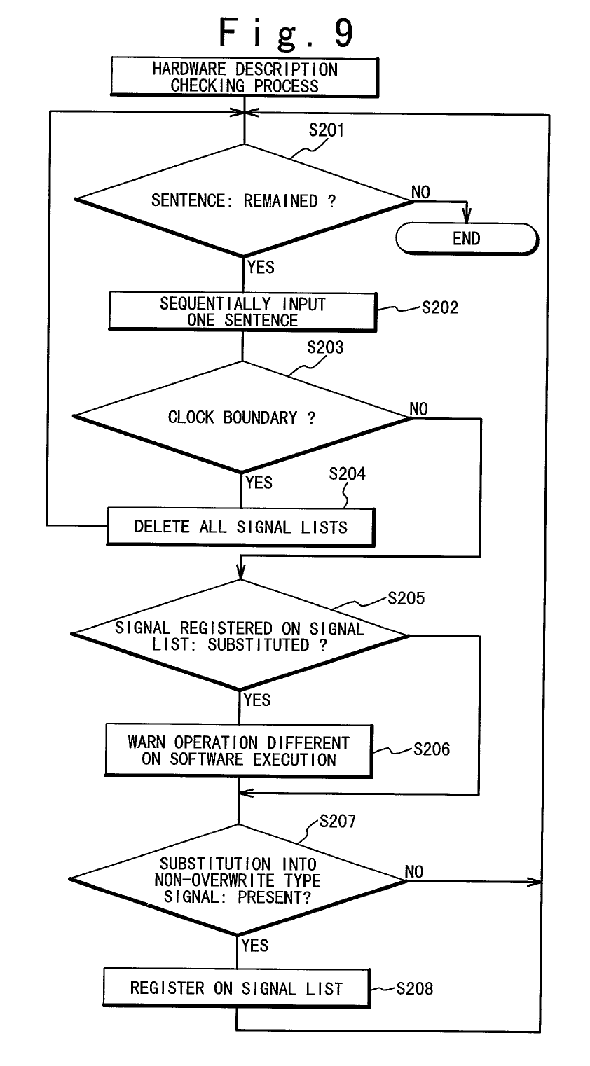

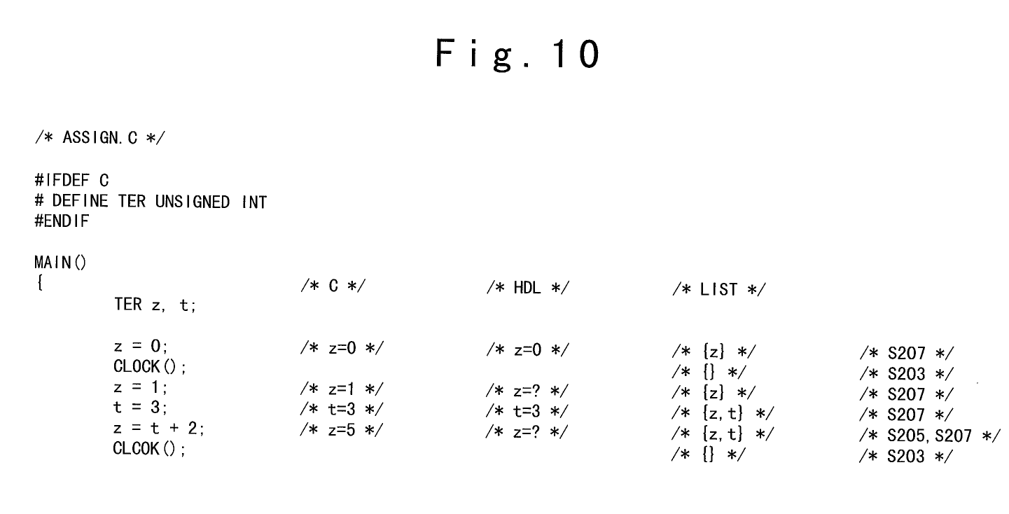

FIG. 9 illustrates a procedure of detecting the presence of a non-overwrite type verification object. FIG. 10 shows an example of the non-overwrite type verification object. The hardware description of the non-overwrite type verification object in the extended C language of the program is:

| | |
|---|---|
| ter z, t; | |
| z = 0; | first sentence |
| clock (); | second sentence |
| z = 1; | third sentence |
| t = 3; | fourth sentence |
| z = t + 2; | fifth sentence |
| clock (); | sixth sentence |

where “ter z, t” and the second and sixth sentences are described in the extended C programming language.

The hardware description verifying section 1 inputs each sentence of the hardware description from the storage unit 4 (step S202), when the sentences are remained (step S201). The first sentence is “z=0”. When the first sentence indicates a clock boundary (Yes at a step S203), all the signals stored in the signal list storing section 2 are deleted (step S204). As the first sentence is not the clock boundary, the procedure goes from the step S202 to a step S205.

It is checked at the step S205 whether the inputted sentence includes substitution to the variable stored in the signal list storing section 2. By now, no variable is registered and the procedure jumps to a step S207. When the substitution is present, an alarm is outputted before the procedure moves to the step S207.

It is then checked at the step S207 whether the substitution to the non-overwrite type signal z is present. Since the first sentence includes the substitution to the non-overwrite type signal z, the procedure advances to a step S208. At the step S208, when the substitution to the non-overwrite type signal is present, the non-overwrite type variable substituted in the sentence is stored in the signal list storing section 2. Therefore, when the non-overwrite type variable z in the first sentence has been stored in the signal list storing section 2, the procedure returns back to the step S201.

Next, the second sentence, clock ( ), is inputted to the hardware description verifying section 1. Since the second sentence indicates a clock boundary, the variables stored in the signal list storing section 2 are all deleted. In this example, the variable z is deleted at the step S204. Then, the procedure then returns back to the step S201.

The third sentence “z=1” is inputted to the hardware description verifying section 1. As the third sentence indicates no clock boundary, the procedure jumps to the step S205. By now, no variable is registered and the procedure goes from the step S205 to the step S208 via the step S207 where the signal z is registered in the signal list storage section 2.

Next, the fourth sentence “t=3” is inputted to the hardware description verifying section 1. Since the fourth sentence indicates no clock boundary, the procedure jumps to the step S205. Since the signal list storage section 2 holds z but not t, the procedure goes from the step S205 to the step S207. Since the substitution to the non-overwrite type signal is present, the variable t is registered. Then, the procedure returns back to the step S201.

Next, the fifth sentence “z=t+2” is inputted to the hardware description verifying section 1. Since the fifth sentence indicate no clock boundary, the procedure jumps to the step S205. Since the variable z in the fifth sentence is the variable registered in the signal list storing section 2, an alarm is outputted at a step S206. Then, it is determined at the step S207 that the substitution to the non-overwrite type variable z is present, and then, the variable z in the fifth sentence is registered in the signal list storing section 2 at the step S208. Next, the sixth sentence is inputted to the hardware description verifying section 1 and the two variables z are deleted from the signal list storing section 2.

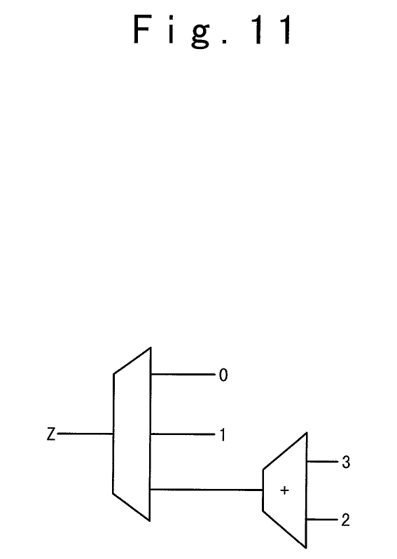

In the third and fifth sentences between the clock boundary descriptions, the variable z in the fifth sentence may be overwritten by the variable z in the third sentence. In such a case, interpretation in the compiler for the extended C language is different from that in the HDL, as shown in FIG. 10. As shown in FIG. 11, it is unknown in the HDL whether either of the third or fifth sentence is valid, so that the variable z at the clock timing is not defined, while the values of 1 and 5 are substituted for the third sentence and the fifth sentence in the C language, respectively. The sentences before and after the clock boundary of which the physical operation is executed at the timing of a clock signal are interpreted differently between the C language and the HDL language or may be not calculated. Depending on the interpretation as either overwriting or unknown, the result of the operation will be different.

As described above, the values remains unchanged after the substitution to the variable and are updated at once upon the description of clock boundary in the register type. On the other hand, one variable cannot be substituted two or more times between any two clock boundary descriptions in the non-overwrite type. Since the extended C programming language in which a clock boundary sentence can be introduced includes elaborate physical descriptions, there are cases that intentions of the designer fail to be expressed in the physical description. In the present invention, a portion of the hardware description where the equality may be lost is detected, without examining the equality between the functional verification of the hardware descriptions and the functional verification of the behavior synthesis of hardware descriptions. Thus, the designer or user can rewrite the detected portion in the source program to avoid different interpretations. The rewritten program contains no discrepancies in the interpretation and the verification of the equality can be omitted.

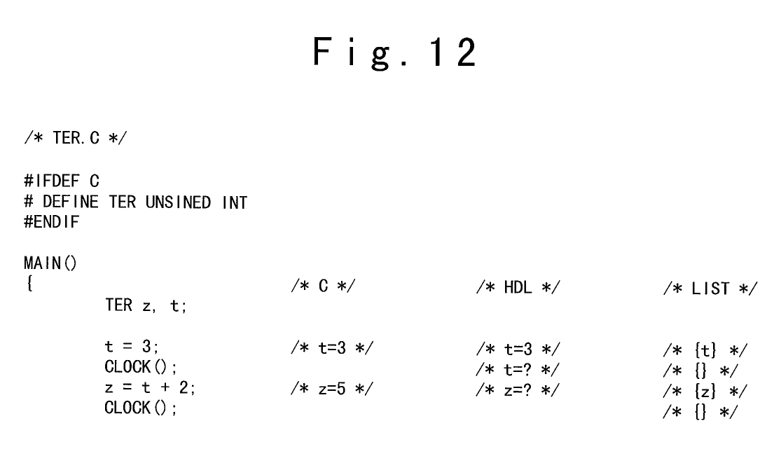

The other types described below are also defined equally and if a discrepancy is found, an alarm is outputted. FIG. 12 illustrates an example of the non-register type verification object. The hardware description of the non-register type verification object in an extended C language of the program is as follows:

3. Non-Register Type Verification Objects

t=3;

clock ( );

z=t+2;

clock ( );

In the program, the value of t is described outside of the clock period between two clock boundaries. The value of t for which 3 is substituted is valid only inside the clock period where the value of t is defined. The value of 3 for the variable t is invalid when the variable t is referred to over the clock boundary. Such a variable t is called the non-register type.

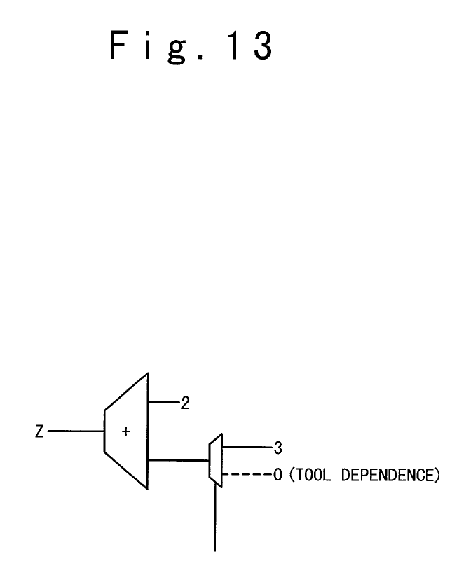

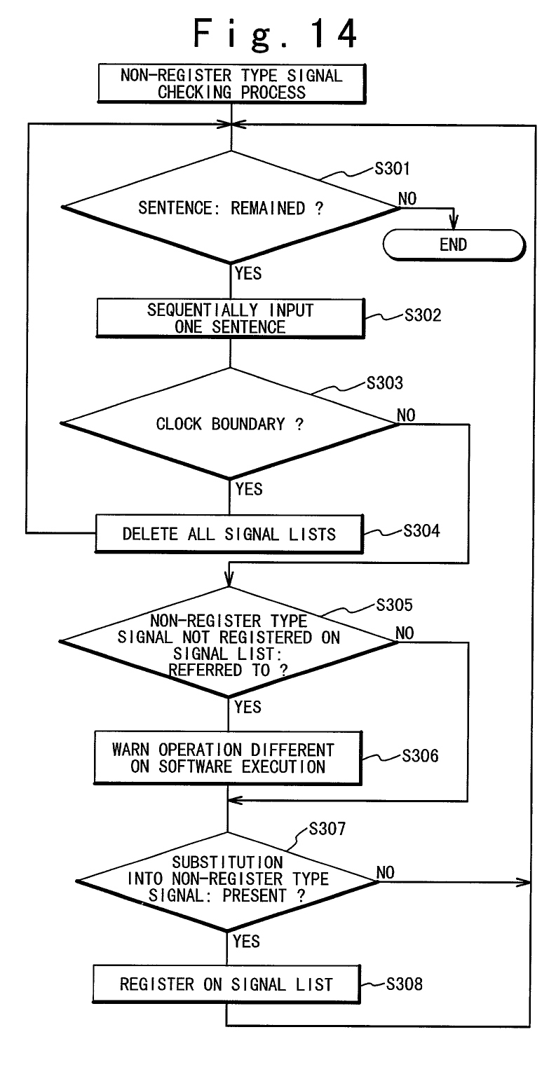

The value substituted previously can be used in the C language. However, it is interpreted in the hardware description language (HDL) that the substitution to the variable t is not present in the same step. Therefore, the value to be referred to depends on a synthesizing tool, as shown in FIG. 13. The value of the variable z which refers to the non-register type variable t whose value is not substituted before the referencing operation in the same step may be different between the extended C language and the hardware description language. As shown in FIG. 12, z=5 is in the extended C language but z is unknown in the hardware description language. Since the third sentence “z=t+2” refers to the non-register type variable t not registered in the signal list storage section 2, an alarm is outputted through steps S305 and S306 shown in FIG. 14. When it is determined at a step S307 that the substitution to the non-register type signal is present, the non-register type signal t is registered in the signal list storage section 2 at a step S308. The other steps are same as those shown in FIG. 6.

4. Wiring Line Type Verification Object

The hardware description of the wiring line type verification object in an extended C language of the program is as follows:

t=3;

clock ( );

z=t+2;

t=1;

clock ( );

In the above source program, the variable t is described two times in the same clock period between two clock boundaries. The variable t whose substituted value is reflected in all the references at the clock period is called of the wiring line type. The signal represents a pattern of signal wiring line in an actual circuit.

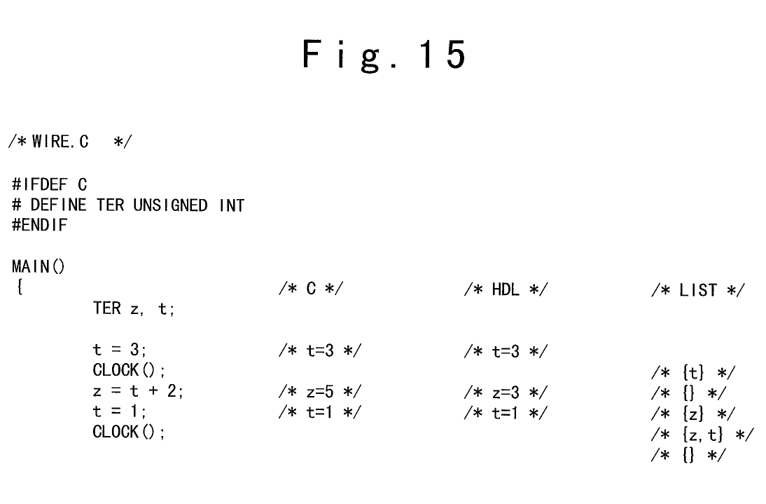

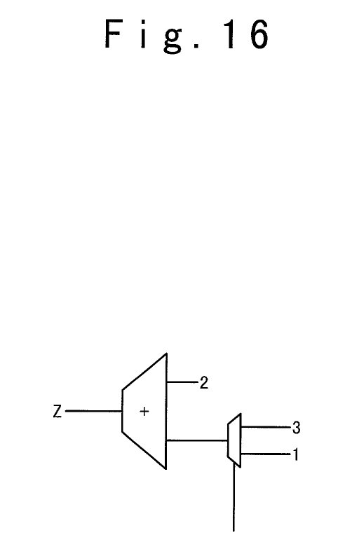

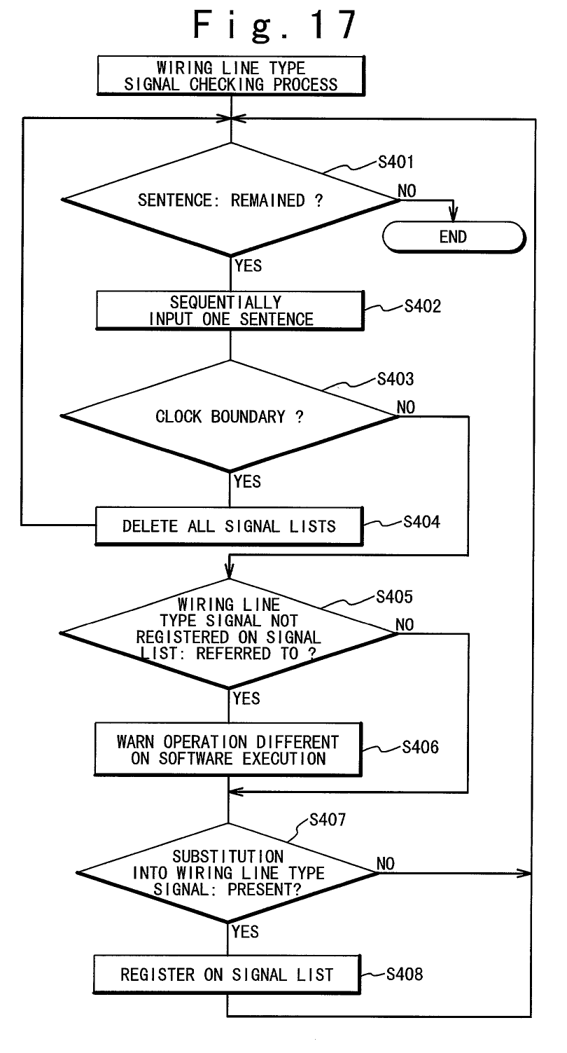

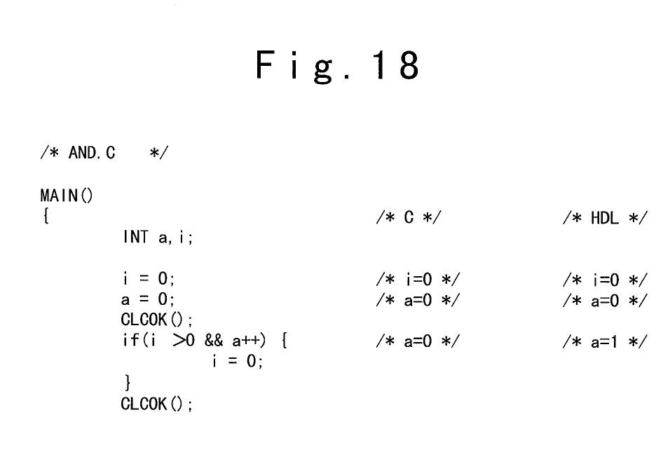

The value substituted previously can be used in the C language. On the other hand, only the value substituted to variable t in the same clock period can be used in the hardware description language. As shown in FIG. 16, the substituted value of the variable t is different between the extended C language and the hardware description language. The value is either 3 equal to the previous value in the extended C language or 1 equal to the current value in the hardware description language. Referring to FIG. 15, z=5 and t=1 are defined in the C language while z=3 and t=1 in the hardware description language. Since the third sentence “z=t+2” refers to the wiring line type variable t not registered in the signal list storage section 2, an alarm is outputted through steps S405 and S406 shown in FIG. 17. When it is determined at a step S407 that the substitution to the wiring line type signal is present, the wiring line type signal t is registered in the signal list storage section 2 at a step S408. The other steps are same as those shown in FIG. 6. The verifying result is shown in FIG. 15.

5. Operator Type Verification Object

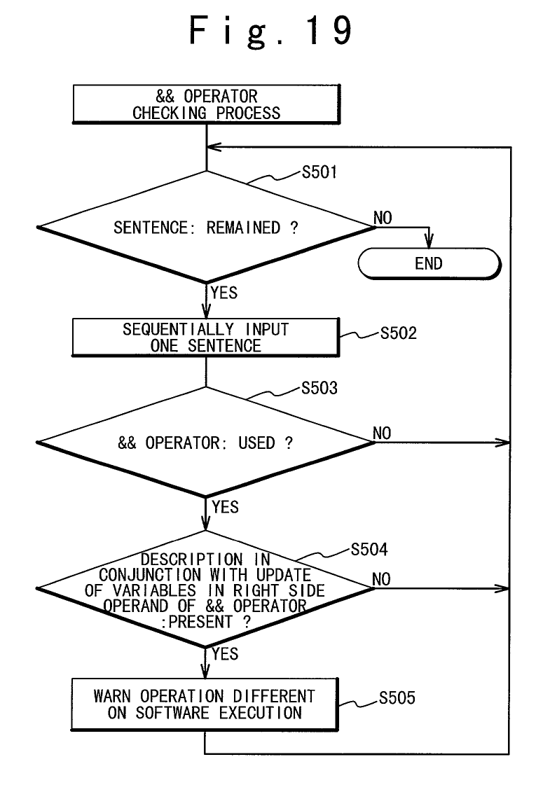

FIG. 18 illustrates an example of the operator type verification object. The hardware description of the operator type verification object in an extended C language of an original program is as follows:

i=0;

a=0;

clock ( );

if (i>0&&a++){

i=0;

}

clock ( );

where a++ means that a is incremented when being evaluated. With the operator && in the program is in the C language, the right operand a++ is evaluated when the left operand (i>0) is true. In the hardware description language, both of the left and right operands of the operator && are evaluated in parallel regardless of whether the left operand is true or not. When the left operand of the operator && is not true, the evaluation of the right operand may be different between the C language and the hardware description language. As shown in FIG. 19, when the operator && is used at a step S503 and the description for updating the variable is present in the right operand of the operator && (step S504), an alarm is outputted at a step S505. Also, when the operator && is replaced by another operator for evaluating the right operand only if the left operand is not true, an alarm can be outputted as shown in FIG. 19. The other steps are same as those shown in FIG. 6.

In the system and method for verifying the hardware description according to the present invention, a portion of the description where its interpretation is different between the programming language and the hardware description language is detected and an alarm is outputted to indicate that the portion may interrupt the operation of simulating the functional verification, hence allowing the program to be modified with much ease or eliminating the interruption. In particular, the verification of equality will successfully be omitted.

What is claimed is:

1. A hardware description verifying system comprising:
a storage unit which stores a source program for hardware description in a program language;
an output unit; and
a processor which detect a portion of said source program different in logic interpretation between a case of compiling said source program using a compiler and a case of behavioral synthesis, and outputs existence of said source program portion to said output unit.

2. The hardware description verifying system according to claim 1, wherein said processor detects said source program portion in which a variable of a register type is referred to at a clock timing after substitution to said variable at said clock timing.

3. The hardware description verifying system according to claim 2, wherein said processor comprises:
a signal list storage section; and
a processing section which sequentially reads out sentences of said source program, deletes a storage content in said signal list storage section when the read out sentence indicates a clock boundary, stores said variable in said signal list storage section when said read out sentence indicates the substitution to said variable at said clock timing, and outputs the existence of said read out sentence to said output unit when said read out sentence refers to said variable which is stored in said signal list storage section.

4. The hardware description verifying system according to claim 1, wherein said processor detects said source program portion in which substitution to a variable of a non-overwrite type is carried out twice or more at a clock timing.

5. The hardware description verifying system according to claim 4, wherein said processor comprises:
a signal list storage section; and
a processing section which sequentially reads out sentences of said source program, deletes a storage content in said signal list storage section when the read out sentence indicates a clock boundary, stores said variable in said signal list storage section when said read out sentence indicates the substitution to said variable at said clock timing and said variable is not stored in said signal list storage section, and outputs the existence of said read out sentence to said output unit when said read out sentence indicates the substitution to said variable at said clock timing and said variable is stored in said signal list storage section.

6. The hardware description verifying system according to claim 1, wherein said processor detects said source program portion in which a variable for a non-register type is referred to at a clock timing without substitution of said value to said variable at said clock timing.

7. The hardware description verifying system according to claim 6, wherein said processor comprises:
a signal list storage section; and
a processing section which sequentially reads out sentences of said source program, deletes a storage content in said signal list storage section when the read out sentence indicates a clock boundary, stores said variable in said signal list storage section when said read out sentence indicates the substitution to said variable at said clock timing, and outputs the existence of said read out sentence to said output unit when said read out sentence refers to said variable which is not stored in said signal list storage section, at said clock timing.

8. The hardware description verifying system according to claim 1, wherein said processor detects said source program portion in which a variable of a wiring line is referred to at a clock timing and then a value is substituted to said variable at said clock timing.

9. The hardware description verifying system according to claim 8, wherein said processor comprises:
a signal list storage section; and
a processing section which sequentially reads out sentences of said source program, deletes a storage content in said signal list storage section when the read out sentence indicates a clock boundary, stores said variable in said signal list storage section when said read out sentence indicates the substitution to said variable at said clock timing, and outputs the existence of said read out sentence to said output unit when said read out sentence refers to said variable which is not stored in said signal list storage section, at said clock timing.

10. The hardware description verifying system according to claim 1, wherein said processor detects said source program portion in which a logical operator is used and a right operand of the operator type includes a variable with substitution.

11. A hardware description verifying method comprising:
(a) detecting a portion of a source program different in logic interpretation between a case of compiling said source program using a compiler and a case of behavioral synthesis, said source program for hardware description being described in a program language; and
(b) alarming existence of said source program portion.

12. The hardware description verifying method according to claim 11, wherein said source program portion is a portion in which a variable of a register type is referred to a clock timing after substitution to said variable at said clock timing.

13. The hardware description verifying method according to claim 12, wherein said (a) detecting comprises:
sequentially reading out sentences of said source program;
deleting a storage content in a signal list storage section when the read out sentence indicates a clock boundary;
storing said variable in said signal list storage section when said read out sentence indicates the substitution to said variable at said clock timing; and
detecting said read out sentence as said source program portion when said read out sentence refers to said variable which is stored in said signal list storage section.

14. The hardware description verifying method according to claim 11, wherein said source program portion is a portion in which substitution to a variable of a non-overwrite type is carried out twice or more at a clock timing.

15. The hardware description verifying method according to claim 14, wherein said (a) detecting comprises:
sequentially reading out sentences of said source program;
deleting a storage content in a signal list storage section when the read out sentence indicates a clock boundary;
storing said variable in said signal list storage section when said read out sentence indicates the substitution to said variable at said clock timing and said variable is not stored in said signal list storage section; and
detecting said source program portion when said read out sentence indicates the substitution to said variable at said clock timing and said variable is stored in said signal list storage section.

16. The hardware description verifying method according to claim 11, wherein said source program portion is a portion in which a variable for a non-register type is referred to at a clock timing without substitution of said value to said variable at said clock timing.

17. The hardware description verifying method according to claim 16, wherein said (a) detecting comprises:
sequentially reading out sentences of said source program;
deleting a storage content in a signal list storage section when the read out sentence indicates a clock boundary;
storing said variable in said signal list storage section when said read out sentence indicates the substitution to said variable at said clock timing; and
detecting said source program portion when said read out sentence refers to said variable which is not stored in said signal list storage section, at said clock timing.

18. The hardware description verifying method according to claim 11, wherein said source program portion is a portion in which a variable of a wiring line is referred to at a clock timing and then a value is substituted to said variable at said clock timing.

19. The hardware description verifying method according to claim 18, wherein said (a) detecting comprises:
sequentially reading out sentences of said source program;
deleting a storage content in said signal list storage section when the read out sentence indicates a clock boundary;
storing said variable in said signal list storage section when said read out sentence indicates the substitution to said variable at said clock timing; and
detecting said source program portion when said read out sentence refers to said variable which is not stored in said signal list storage section, at said clock timing.

20. The hardware description verifying method according to claim 11, wherein said processor detects said source program portion in which a logical operator is used and a right operand of the operator type includes a variable with substitution.

21. A program for a hardware description verifying method comprising:
(a) detecting a portion of a source program different in logic interpretation between a case of compiling said source program using a compiler and a case of behavioral synthesis, said source program for hardware description being described in a program language; and
(b) alarming existence of said source program portion.

22. The program according to claim 21, wherein said source program portion is a portion in which a variable of a register type is referred to at a clock timing after substitution to said variable at said clock timing.

23. The program according to claim 22, wherein said (a) detecting comprises:
sequentially reading out sentences of said source program;
deleting a storage content in a signal list storage section when the read out sentence indicates a clock boundary;
storing said variable in said signal list storage section when said read out sentence indicates the substitution to said variable at said clock timing; and
detecting said read out sentence as said source program portion when said read out sentence refers to said variable which is stored in said signal list storage section.

24. The program according to claim 21, wherein said source program portion is a portion in which substitution to a variable of a non-overwrite type is carried out twice or more at a clock timing.

25. The program according to claim 24, wherein said (a) detecting comprises:
sequentially reading out sentences of said source program;
deleting a storage content in a signal list storage section when the read out sentence indicates a clock boundary;
storing said variable in said signal list storage section when said read out sentence indicates the substitution to said variable at said clock timing and said variable is not stored in said signal list storage section; and
detecting said source program portion when said read out sentence indicates the substitution to said variable at said clock timing and said variable is stored in said signal list storage section.

26. The program according to claim 21, wherein said source program portion is a portion in which a variable for a non-register type is referred to at a clock timing without substitution of said value to said variable at said clock timing.

27. The program according to claim 26, wherein said (a) detecting comprises:
sequentially reading out sentences of said source program;
deleting a storage content in a signal list storage section when the read out sentence indicates a clock boundary;
storing said variable in said signal list storage section when said read out sentence indicates the substitution to said variable at said clock timing; and
detecting said source program portion when said read out sentence refers to said variable which is not stored in said signal list storage section, at said clock timing.

28. The program according to claim 21, wherein said source program portion is a portion in which a variable of a wiring line is referred to at a clock timing and then a value is substituted to said variable at said clock timing.

29. The program according to claim 28, wherein said (a) detecting comprises:
sequentially reading out sentences of said source program;
deleting a storage content in said signal list storage section when the read out sentence indicates a clock boundary;
storing said variable in said signal list storage section when said read out sentence indicates the substitution to said variable at said clock timing; and
detecting said source program portion when said read out sentence refers to said variable which is not stored in said signal list storage section, at said clock timing.

30. The program according to claim 21, wherein said processor detects said source program portion in which a logical operator is used and a right operand of the operator type includes a variable with substitution.
